(19) United States
(12) Patent Application Publication
(10) Pub. No.: US 2010/0176731 A1
(43) Pub. Date: Jul. 15, 2010

(54) Adaptor and Illumination Apparatus

(76) Inventors: Young Hwan Lee, Seoul (KR); Kwan Soo Jang, Seoul (KR); Chung Hyun Cho, Goyang-si (KR)

Correspondence Address: THE LAW OFFICES OF ANDREW D. FORTNEY, PH.D., P.C., 215 W FALLBROOK AVE SUITE 203, FRESNO, CA, 93711, US

(21) Appl. No.: 12/684,848

(22) Filed: Jan. 8, 2010

(30) Foreign Application Priority Data
Jan. 9, 2009 (KR) 10-2009-0001712

(51) Int. Cl. H05B 41/36

(52) U.S. Cl. 315/150; 315/291; 313/504

(57) ABSTRACT

An adaptor includes a power connection unit electrically connected to a power line that may be extended from an AC plug; a power supply unit electrically connected to the power connection unit, configured to supply power; a light emitting device driver that generates driving power from the power supplied by the power supply unit; and a controller that controls the light emitting device driver.

The present application claims priority under 35 U.S.C. §119(e) of Korean Patent Application No. 10-2009-0001712 (filed on Jan. 9, 2009) which is hereby incorporated by reference in its entirety.

### BACKGROUND

### Description of the Related Art

Embodiments of the invention relate to an adaptor and an illumination apparatus.

At the present time, a fluorescent lamp or an incandescent lamp has been widely used as an illumination apparatus. In particular, the fluorescent lamp has low power consumption and high brightness so that it has been widely used in offices and homes.

Meanwhile, an illumination apparatus that can replace the fluorescent lamp or the incandescent lamp has been recently developed and, representatively, an illumination apparatus using a light emitting diode (LED) has been introduced.

However, in the case of the illumination apparatus using the LED, it is driven with a voltage different from the fluorescent lamp or the incandescent lamp, causing a problem in that the power supply apparatus including conventionally installed sockets should be replaced when using the illumination apparatus using the LED.

### SUMMARY

Embodiments of the invention provide an illumination apparatus using an LED or OLED.

Embodiments of the invention provide an adaptor suitable to drive an illumination apparatus using LED or OLED.

Embodiments of the invention provide an adaptor that can be used to directly connect to a plug to which AC power is supplied, and an illumination apparatus using an LED or an OLED that can be connected to the adaptor.

An adaptor according to various embodiments may include a power connection unit that is electrically connected to a power line (e.g., that may be extended from a plug for an alternating current [AC] power socket); a power supply unit that is electrically connected to the power connection unit, configured to supply power; a light emitting device driver that generates driving power from the power supplied from the power supply unit; and a controller that controls the light emitting device driver.

An illumination apparatus according to embodiments may include an adaptor that includes a power connection unit (e.g., that may be electrically connected to a power line extended from a plug for an alternating current [AC] power socket) and a power supply unit electrically connected to the power connection unit, configured to supply power; a light emitting device driver that generates driving power from the power supplied from the power supply unit; a controller that controls the light emitting device driver; an interface connection unit that supplies the driving power generated by the light emitting device driver; and a light emitting device illumination unit including a plurality of light emitting devices connected to an interface in communication the interface connection unit and that emit light according to the driving power.

### BRIEF DESCRIPTION OF THE DRAWINGS

FIG. 1 is a diagram for explaining an exemplary adaptor and illumination apparatus;

FIG. 2 is a block diagram for explaining a configuration of the exemplary adaptor and illumination apparatus;

FIG. 3 is a diagram showing an exemplary AC-DC converter and a regulator in the exemplary adaptor;

FIG. 4 is a diagram showing an exemplary light emitting device driver and a light emitting device unit in the exemplary illumination apparatus; and

FIG. 5 is a diagram showing an exemplary light emitting device driver for the exemplary illumination apparatus.

### DETAILED DESCRIPTION

In the drawings, the thickness or size of each layer is exaggerated, omitted or otherwise illustrated for the convenience and clarity of explanation. Also, the size of each constituent does not completely reflect its actual size.

Hereinafter, an illumination apparatus according to various embodiments will be described with reference to the accompanying drawings.

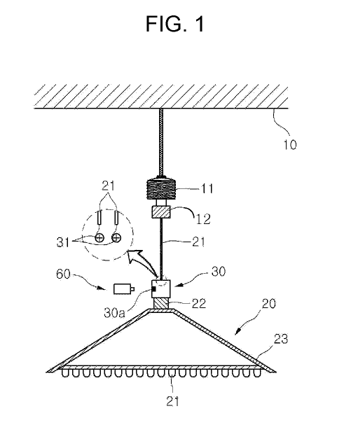

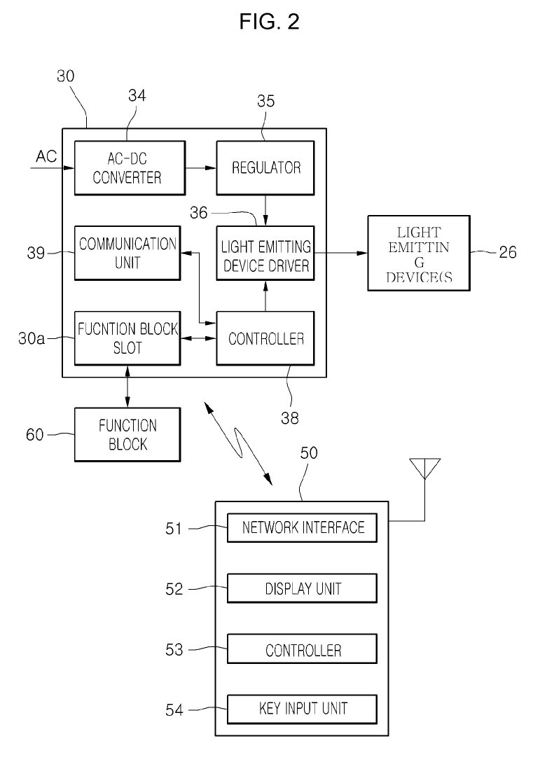

FIG. 1 is a diagram for explaining an adaptor and an illumination apparatus according to various exemplary embodiments, and FIG. 2 is a block diagram for explaining a configuration of the exemplary adaptor and illumination apparatus.

Referring first to FIG. 1, an illumination apparatus according to an exemplary embodiment includes a lamp shown as a light emitting device illumination unit 20 and an adapter 30 that can drive the lamp.

The light emitting device illumination unit 20 includes a plurality of light emitting devices 21 that are installed on a light emitting device supporting part 23 and an interface 22 that is detachably and electrically connected to the adaptor 30 and is formed on one side of the light emitting device supporting part 23.

The light emitting device supporting part 23 may have a shade (or conical) shape, and the inner side thereof may have installed thereon or therein the light emitting devices 21. The light emitting device supporting part 23 may have another shape, such as cylindrical, cubical, hemispherical, or other three-dimensional shape comprising regular or irregular polygons, circles, ovals, partial spheres, etc.

One side of the adaptor 30 includes an interface connection unit, such that it can be detachably connected to the interface 22. Therefore, the adaptor 30 can be electrically connected to the light emitting device illumination unit 20 and can support the light emitting device illumination device 20. The other side of the adaptor 30 includes a power connection unit 31 that is connected to the power line 21 extending from the plug 12.

The adaptor 30 according to various embodiments is connected to a plug jack or socket 11 to which commercial AC power is supplied through the power line 21 and the plug 12 that is electrically connected thereto.

FIG. 1 shows that the plug jack/socket 11 extending from a ceiling 10 is connected to the plug 12, and the power line 21 extending from the plug 12 is electrically connected to the adaptor 30 through the power connection unit 31.

The adaptor 30 receives power through the plug 12 to drive the light emitting device illumination unit 20.

In the light emitting device illumination unit 20, the plurality of light emitting devices 21 are arranged on the inner side of the light emitting device supporting part 23. Each light emitting device 21 may be an LED or an OLED.

The light emitting device supporting part 23 may include wiring configured to supply power to each light emitting device 21 from the adaptor 30. The wiring may be connected to each light emitting device 21 serially or in parallel. The light emitting device supporting part 23 can include an antireflective coating layer (not shown) comprising a silver (Ag) coating or aluminum (Al) coating, thereby making it possible to increase efficiency of light from the light emitting devices 21. Each of the plurality of light emitting devices 21 may emit red, blue, green, or white light. In one embodiment, a first subgroup of light emitting devices 21 emits red light, a second subgroup of light emitting devices emits blue light, a third subgroup of light emitting devices 21 emits green light, and a fourth subgroup of light emitting devices 21 emits white light.

Further, the adaptor 30 can include a function block slot 30a in which a function block 60 (e.g., one or more of an infrared sensor, an image sensor, a fire sensor, etc.) is installed and/or can be inserted.

Referring to FIG. 2, in the exemplary adaptor and illumination apparatus, the adaptor 30 may include an AC-DC converter 34, a regulator 35, one or more light emitting device drivers 36, a controller 38, a communication unit 39, and a function block slot 30a, and the light emitting device illumination unit 20 may include a light emitting device unit 26.

Describing in more detail, the function block slot 30a of the adaptor 30 may have a function block 60 inserted therein. For example, the function block 60 may include a USB connector, and the function block slot 30a may include a slot in which the USB connector can be inserted. An interface and a communication scheme between the function block slot 30a and the function block 60 can be variously selected as is known in the art.

The power supply unit in the adaptor 30 that supplies power (indirectly) to the light emitting device unit 26 includes the AC-DC converter 34 and the regulator 35.

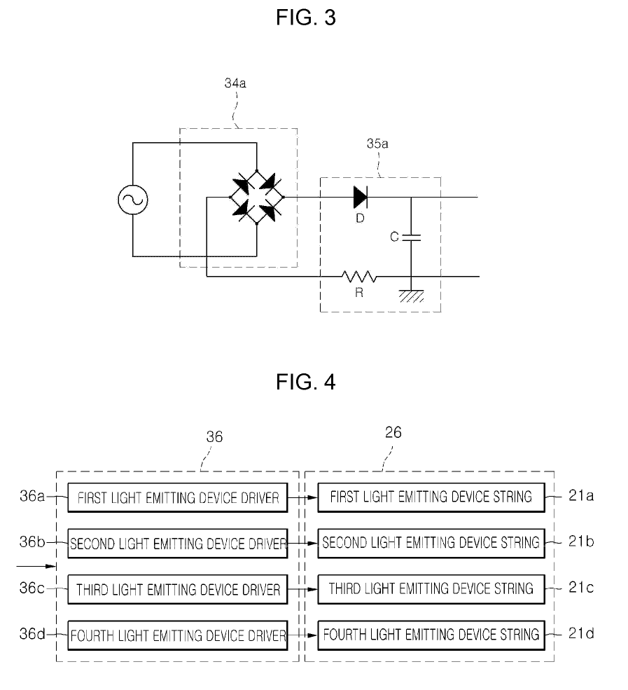

The AC-DC converter 34 converts the AC power supplied through the power connection unit 31 connected to the power line 21 into DC power, and the regulator 35 can output the DC power output from the AC-DC converter 34 at a predetermined DC voltage. For example, as shown in FIG. 3, the AC-DC converter 34 and the regulator 35 may include a bridge rectifying circuit 34a and a smoothing, regulatory or filter circuit 35a. In other words, the power supply unit of the adaptor 30 receives AC power from the plug 12 and converts it into DC power for the light emitting device driver(s) 36.

The light emitting device driver(s) 36 output the DC voltage from the regulator 35 as a driving power suitable to drive the plurality of light emitting devices 21. In one embodiment, the driving power that drives (e.g., turns on and off) the plurality of light emitting devices 21 is transmitted as one or more driving pulses.

For example, as shown in FIG. 4, the light emitting device driver 36 may include a first light emitting device driver 36a, a second light emitting device driver 36b, a third light emitting device driver 36c, and a fourth light emitting device driver 36d. Each of the first light emitting device driver 36a, the second light emitting device driver 36b, the third light emitting device driver 36c, and the fourth light emitting device driver 36d drives a first light emitting device string 21a, a second light emitting device string 21b, a third light emitting device string 21c, and a fourth light emitting device string 21d in the light emitting device unit 26 of the light emitting device illumination unit 20. Each of the first through fourth light emitting device strings 21a-21d are in parallel with each other, but may also be connected serially or in parallel with the corresponding light emitting device driver 36a-36d.

For example, the first light emitting device string 21a may connect the plurality of LEDs or OLEDs serially, and each of the LEDs or OLEDs in the first light emitting device string 21a may emit red light. The second light emitting device string 21b may connect the plurality of LEDs or OLEDs in series, and each of the LEDs or OLEDs in the second light emitting device string 21b may emit green light The third light emitting device string 21c may connect the plurality of LEDs or OLEDs in series, and each of the LEDs or OLEDs in the third light emitting device string 21c may emit blue light. Finally, the fourth light emitting device string 21d may connect the plurality of LEDs or OLEDs in series, and each of the LEDs or OLEDs in the fourth light emitting device string 21d may emit white light.

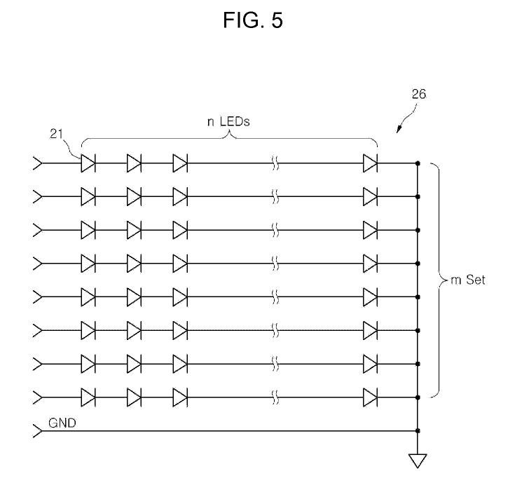

For example, as shown in FIG. 5, the light emitting device unit 26 may include a plurality of light emitting devices 21, and the plurality of light emitting devices 21 can form the plurality of light emitting device strings as shown in FIG. 4. For example, FIG. 5 shows m LED strings to which n LEDs are connected in series, wherein m is an integer of from 1 to 7, and n is an integer of at least 2. When m is 1, the LED(s) 21 may emit white light. When m is 2, the LED(s) 21 may emit white light and another color or light, such as red, green or blue light. When m is 3, the LED(s) 21 may emit red, green and blue light. When m is 4, the LED(s) 21 may emit white, red, green and blue light.

Referring back to FIGS. 3-4, the light emitting device driver 36 controls or comprises the first light emitting device driver 36a, the second light emitting device driver 36b, the third light emitting device driver 36c, and the fourth light emitting device driver 36d. In turn, the first through fourth light emitting device drivers 36a-36d may control the length, interval, voltage/power, ramp rate, etc., of the driving pulse of the first light emitting device string 21a, the second light emitting device string 21b, the third light emitting device string 21c, and the fourth light emitting device string 21d, respectively, thereby causing light having various colors, patterns, durations and/or intensities to be emitted.

For example, when the driving pulse is applied to only the first light emitting device string 21a by driving only the first light emitting device driver 36a, the light emitting device illumination unit 20 may emit red light. In addition, when the driving pulse is applied to only the fourth light emitting device string 21d by driving only the fourth light emitting device driver 36d, the light emitting device illumination unit 20 may emit white light. Moreover, when all of the first through fourth light emitting device drivers 36a-36d apply driving pulses to the first through fourth light emitting device strings 21a-21d, the light emitting device illumination unit 20 emits more white light.

Referring back to FIG. 2, the controller 38 controls the first light emitting device driver 36a, the second light emitting device driver 36b, the third light emitting device driver 36c, and the fourth light emitting device driver 36d to drive the first light emitting device string 21a, the second light emitting device string 21b, the third light emitting device string 21c, and the fourth light emitting device string 21d. For example, the controller 38 can provide different driving pulse information to the first light emitting device driver 36a, the second light emitting device driver 36b, the third light emitting device driver 36c, and the fourth light emitting device driver 36d, thereby making it possible to vary the color, brightness, saturation, flickering, etc., of light emitted from the plurality of light emitting devices 21. The controller is also configured to receive instructions from the function block(s) 60 (through the function block slot(s) 30a) and the communication unit 39, and process such instructions to turn on and off light emitting devices 21 and/or the vary the color, intensity, pattern, etc. of light emitted from the plurality of light emitting devices 21.

The communication unit 39 provides communications from a remote control unit 50 (e.g., a remote controller) and the controller 38 so that the light emitting device illumination unit 20 can be remotely controlled by the remote controller 50. The communication unit 39 and the remote controller 50 can communicate according to a wireless communication scheme (for example, according to a Zigbee standard).

The remote controller 50 includes a network interface 51 that transmits data and/or commands to the communication unit 39, a key input unit 54 that receives inputs (e.g., operational commands) from a user, a display unit 52 that shows an operational state of or to the user, and a controller 53 that controls the network interface 51 and the display unit 52 according to inputs and/or signals from the key input unit 53. Therefore, the user transmits a control command to the communication unit 39 using the remote controller 50, and the communication unit 39 transmits the control command from the user to the controller 38, thereby making it possible to control (remotely) the light emitting device illumination unit 20. For example, the user can control emission of light of a specific color from the light emitting device illumination unit 20 using the remote controller 50, an operation in which the controller 38 can selectively drive the first light emitting device driver 36a, the second light emitting device driver 36b, the third light emitting device driver 36c, and/or the fourth light emitting device driver 36d according to the signal input from the communication unit 39.

In addition, the user can turn on or turn off the light emitting device illumination unit 20 using the remote controller 50 after a predetermined time elapses. In other words, the controller 38 can control the light emitting device driver 36 according to a change in or length of time by inputting a timer function or operation.

The function block 60 is detachably connected to the function block slot 30a of the adaptor 30 to connect to the controller 38. The function block 60 may include one or more of an infrared sensor, an image sensor, a motion sensor, or a fire sensor. The function block 60 may also include hardware, firmware and/or software for programming a predetermined light pattern and/or on-off duration (timing) for the light emitting device unit 26. The adaptor 30 may include more than one function block slot 30a, in which case more than one function block 60 may be inserted and/or installed.

For example, the function block 60 can be installed with an infrared sensor to perform a security function, and when the motion of the user is sensed through the infrared sensing, the function block 60 transmits the sensed signal to the controller 38, and the controller 38 can transmit the sensed information to the remote controller 50 through the communication unit 39.

In addition, the function block 60 can include an image sensor to perform a security function (e.g., taking a picture periodically or when, e.g., motion is sensed), and the image obtained through the image sensor can be transmitted to the controller 38, and the controller 38 can transmit the image to the remote controller 50 (or other designated apparatus, such as a personal computer or cellular telephone) through the communication unit 39.

In addition, the function block 60 can include a fire sensor to perform a heat sensing function. When a predetermined temperature (or chemical commonly found in smoke) is sensed through the fire sensor, the function block 60 can transmit the sensed signal to the controller 38, and the controller 38 can transmit the sensed information to the remote controller 50 (or other designated apparatus, such as an alarm or a cellular telephone) through the communication unit 39. A speaker (not shown) can be installed in the adaptor 30 or in the function block 60, such that a fire alarm can be outputted from the speaker (e.g., by the controller 38 that obtains the fire sensing signal).

Of course, the user can perform various controls that include on/off operations of the function block 60 through the remote controller 50.

As described above, the illumination apparatus according to the embodiments can be also be connected to the plug 12 that receives the AC power by the adaptor 30 including the AC-DC converter 34, the regulator 35, and the light emitting device driver(s) 36.

In addition, the illumination apparatus according to the embodiments can be remotely controlled when the adaptor 30 includes a communication unit 39, configured to communicate with a remote controller 50.

In addition, the illumination apparatus according to the embodiments can include one or more function block slots 30a and function blocks 60 (which is detachable from the function block slot 30a), thereby making it possible to perform security functions and fire sensing functions, etc., together with the illumination function. Meanwhile, in various embodiments, although the infrared sensor, the image sensor, and/or the fire sensor can be included in the function block 60, the communication unit 39 can also be included in the function block 60, so that it can be detachably installed in the adaptor 30.

Embodiments of the invention can provide an illumination apparatus comprising one or more LEDs or OLEDs.

Embodiments can provide an adaptor suitable to drive the illumination apparatus.

Embodiments can provide an adaptor that can be directly connected to a plug to which AC power is supplied, and the illumination apparatus comprising LED(s) and/or OLED(s) can be connected to the adaptor.

Any reference in this specification to “one embodiment,” “an embodiment,” “example embodiment,” etc., means that a particular feature, structure, or characteristic described in connection with embodiments is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An adaptor, comprising:
a power connection unit electrically connected to a power line;
a power supply unit electrically connected to the power connection unit, configured to supply power;
a light emitting device driver that generates driving power from the power supplied by the power supply unit; and
a controller that controls the light emitting device driver.

2. The adaptor according to claim 1, wherein the power line extends from a plug for an alternating current power socket.

3. The adaptor according to claim 1, wherein the power supply unit includes:
an AC-DC converter that converts AC power into DC power; and
a regulator that outputs a predetermined DC voltage from the DC power.

4. The adaptor according to claim 1, further comprising an interface connection unit connectable to a lamp configured to provide the driving power from the light emitting device driver to the lamp.

5. The adaptor according to claim 1, further comprising a communication unit that provides communications from a remote control unit to the controller.

6. The adaptor according to claim 1, further comprising a function block slot electrically connected to the controller.

7. The adaptor according to claim 6, further comprising a function block connected to the function block slot.

8. The adaptor according to claim 7, wherein the function block is selected from the group consisiting of an infrared sensor, an image sensor, and a fire sensor.

9. An illumination apparatus, comprising:
an adaptor including a power connection unit that is electrically connected to a power line and a power supply unit electrically connected to the power connection unit, the power supply unit being configured to supply power;
a light emitting device driver that generates driving power from the power supplied by the power supply unit;
a controller that controls the light emitting device driver;
an interface connection unit that supplies the driving power from the light emitting device driver; and
a light emitting device illumination unit including a plurality of light emitting devices connected to an interface in communication with the interface connection unit, configured to emit light according to the driving power.

10. The illumination apparatus according to claim 9, wherein the power line extends from a plug for an alternating current power socket.

11. The illumination apparatus according to claim 9, wherein the light emitting device illumination unit includes a light emitting device supporting part that supports the plurality of light emitting devices.

12. The illumination apparatus according to claim 9, wherein the light emitting device comprises a light emitting diode (LED) or an organic light emitting diode (OLED).

13. The illumination apparatus according to claim 9, wherein the power supply unit includes:
an AC-DC converter that converts AC power into DC power; and
a regulator that outputs a predetermined DC voltage from the DC power.

14. The illumination apparatus according to claim 9, further comprising a communication unit that provides communications from a remote control unit to the controller.

15. The illumination apparatus according to claim 9, further comprising a function block slot electrically connected to the controller.

16. The illumination apparatus according to claim 15, further comprising a function block connected to the function block slot.

17. The illumination apparatus according to claim 16, wherein the function block is selected from the group consisiting of an infrared sensor, an image sensor, and a fire sensor.
